(19) United States
(12) Patent Application Publication
(10) Pub. No.: US 2026/0019417 A1
(43) Pub. Date: Jan. 15, 2026

(54) SYSTEM AND METHOD FOR AUTHENTICATION AND VALIDATION OF DIGITAL CONTENT

(71) Applicant: BALDEV KRISHAN, Pleasanton, FL (US)

(72) Inventor: BALDEV KRISHAN, Pleasanton, CA (US)

(21) Appl. No.: 18/769,703

(22) Filed: Jul. 11, 2024

(51) Int. Cl. H04L 9/40

(52) U.S. Cl. CPC H04L 63/0861

(57) ABSTRACT

The present invention discloses a system and method for enhancing the security, authenticity, and traceability of digital content such as images, videos, PDFs, and Word documents. The system comprises a software application to integrates user credentials into digital content using Coalition for Content Provenance and Authenticity (C2PA) standards and verifies access through mobile app-based biometric authentication. The process involves embedding user credentials, such as name, phone number, email, and timestamp, into the content, verifying access via biometric authentication, and ensuring secure posting on social media platforms. The system verifies user identity through fingerprint or facial recognition and may incorporate additional attributes like geolocation. Verified content is stamped with a verification mark, ensuring only authenticated users can access or post the content. The present invention significantly reduces the risk of digital manipulation and fraud thereby enhancing the reliability and transparency of digital content shared on social media.

### TECHNICAL FIELD

The present invention relates to a digital content authentication and metadata retrieval system and a method there of. More specifically, the present invention relates to a system and method for embedding user's credentials into digital content, verifying access of digital content through biometric authentication and ensuring secure posting on social media platform.

### BACKGROUND OF THE INVENTION

In the digital age, the authenticity and provenance of digital content such as images, videos, PDF's, and word document have become increasingly important. With the proliferation of social media platform, ensuring that images and other digital files are genuine and have not been tampered with is crucial for maintaining trust and integrity. There are several methods and systems that are used to verify the authenticity of digital content when shared on social media.

For example, many traditional systems rely on static authentication methods, such as checksums or digital signatures. Checkgums generate a fixed-size string of characters from a block of digital data, which serves as a fingerprint for that data. Digital signatures, on the other hand, use cryptographic techniques to provide proof of the authenticity and integrity of digital content. This process involves generation of unique signature using the private key of the content creator, which can then be verified by others using the corresponding public key. They ensure that the content has not been altered since it was signed by the creator or a trusted entity. However, it can be compromised if the verification keys are exposed or if the content is subtly altered without detection.

Another method includes watermarking embeds identifying information or a digital mark into the content itself. The said marked can be visible or invisible and serves as a proof of authenticity and ownership. Visible watermarks typically include logos, text, or other recognizable symbols superimposed on the content. These watermarks are designed to be noticeable to viewers and act as a deterrent against unauthorized use. For example, a photographer might place a visible watermark on an image to indicate ownership and discourage others from using it without permission. Invisible watermarks, on the other hand, are embedded into the content in a way that is not perceptible to the human eye. These watermarks often involve altering the digital data of the content at a subtle level, such as modifying pixel values in an image or embedding data within the audio spectrum of a sound file. Despite being invisible, these watermarks can be detected and extracted using specialized software. While watermarking adds a layer of protection and authenticity to digital content, it is not foolproof. Watermarks do not prevent determined attackers from using or distributing the content illegally. The presence of a watermark does not guarantee that unauthorized use will not occur. Relying solely on watermarking can create a false sense of security. Users may believe that their content is fully protected, leading them to overlook additional necessary security measures.

Block chain offers a decentralized and immutable ledger where transactions and digital assets, including content, can be securely recorded. This ensures that content history and ownership can be traced back to the original source without alteration. However, recording of every transaction or digital assets on block chain can lead to significant storage and processing requirement.

For user-generated content, 2FA can be used to verify the identity of the creator, adding an additional layer of security and authenticity assurance. The incremental strengthening of identity verification methods over the years—from passwords and security questions to complex passwords and 2FA—has not eliminated these vulnerabilities

However, the current methods of verifying the authenticity of digital content often fall shorts, making it difficult to ensure that the content shared on social media is both genuine and verifiable.

For example, previous systems lack robust mechanisms for tracking the provenance of digital content throughout its lifecycle. This limitation makes it challenging to verify the original source of content and to detect unauthorized modifications.

Additionally, some systems are overly complex or require specialized knowledge to implement and use effectively, limiting their adoption among general users and smaller organizations.

As digital manipulation techniques advance, traditional systems struggle to differentiate between genuine content and sophisticated forgeries, such as deepfakes, which can deceive even trained observers.

The Coalition for Content Provenance and Authenticity (C2PA) has developed standards for establishing the provenance of digital content. These standards provide a framework for ensuring that digital files, such as images, can be traced back to their source, and any modifications can be tracked and verified. However, while C2PA standards effectively address the provenance aspect, they do not inherently provide mechanisms to dynamically authenticate the content in real-time or adapt to evolving security threats.

Therefore, there is need in prior art for a system and method that integrates user credential embedding, biometric verification, and provenance tracking to enhance the security and authenticity of digital content.

Hence, to solve the limitation associated with prior art the present invention discloses a secure system and method for validating and authenticating digital content before they are uploaded to social media platforms by integrating C2PA standards with dynamic authentication system to ensure secure posting on social media platform. The present invention helps to streamline the digital content verification process, thereby enhancing user trust by ensuring only genuine images are shared, and mitigate the spread of misinformation and fraudulent content online.

### OBJECTIVE OF THE INVENTION

The primary objective of the present invention is to provide a system and method for embedding user credentials into digital content, verifying access to digital content through a mobile-based authentication, and authenticating the digital content before they are uploaded to social media platform, ensuring that only genuine and unaltered digital content are shared.

Another objective of the present invention is to provide a system and method for embedding user's credentials into various forms of digital content through Coalition for Content Provenance and Authenticity (C2PA) standards.

Another objective of the present invention is to provide a system and method for digital content authentication where only verified individuals can access or share the content, and it logs and displays credential for transparency.

Another objective of the present invention is to facilitate secure posting of digital content on social media platform by verifying the user's credential through a registered social media accounts or by reading the embedded phone number in the digital content and allowing only verified users to share content.

Another objective of the present invention is to make embedded credentials tamper-evident and securely linked to the digital content, ensuring that any modifications can be detected and that the authenticity of the content is maintained.

Another objective of the present invention is to system and method that automatically stamp digital content with a verification mark once an individual's credentials are authenticated, indicating that the content has been accessed or shared by an authorized user.

### SUMMARY OF THE INVENTION

The present invention discloses a system and method designed to enhance the security, authenticity, and traceability of digital content such as images, videos, pdf, and word document through embedding of user credentials and biometric verification. The invention integrates the Coalition for Content Provenance and Authenticity (C2PA) standards with mobile-app based authentication technology to address the challenges associated with digital content verification and identity validation system.

The present invention is directed to a system and method for embedding user credentials into digital content, verifying access to digital content through a mobile-based authentication, and authenticating the digital content before they are uploaded to social media platform. The system preferably involves software that runs on at least one mobile device having at least one biometric sensor and at least one computing device that may be an interface device. The mobile device runs a mobile application and includes a display unit having a user interface. The system may further include software that runs on at least one server that communicates with the mobile device. The mobile device is in communication with the computing device or interface device. The server is in communication with the computing device or interface device and may be in communication with the mobile device.

One aspect of the present invention relates to a system and method for embedding user credentials into digital content, verifying access to digital content through biometric authentication, and ensuring secure posting on social media platform. The system comprises a software application that resides on a user's device (e.g., a smart phone or any other electronic device) for embedding user's credentials associated with the content creator of digital content and verification of digital content, before they are uploaded to social media platform. The system allows content creators to embed their user credentials (e.g., name, phone number, email address, and time stamp) with Coalition for Content Provenance and Authenticity (C2PA) standards, thereby making the credentials tamper-evident and securely linked to the digital content. Additionally, the creator may include credentials of other individuals who may have authorized to access the digital content shared by the content creator on social media platform or any other application.

According to another aspect of the present invention, the system may provide access to digital content. To access the digital content, a user may download the mobile application to the mobile device. The mobile application prompts the individuals to verify the credentials attempting to open the digital content. When an individual tries to access the secured digital content, the system initiates a thorough verification process to ensure that only authorized users can view the document. The application responsible for managing the content sends a verification request to a designated mobile app, such as iVALT, which is linked to the phone number embedded within the document. Upon receiving the request, the mobile app prompts the individual to undergo biometric authentication, such as fingerprint scanning or facial recognition. Depending on the specific security protocols in place, the app may also verify additional attributes of the individual, such as their geolocation or device ID. Once the individual successfully passes the biometric authentication, the system grants them access to the digital content. As a security measure, the content is displayed along with the credentials of the verified individual, providing transparency and accountability regarding who accessed the document. Furthermore, the content is stamped with a verification mark, indicating that the access attempt has been authenticated successfully.

According to another aspect of the present invention, the system allows user to securely post digital content on social media platform, ensuring that only verified users can share the content. This can be accomplished through two distinct methods. In the first method, if the individual's social media account is registered with a mobile number, the social media platform sends a verification request to a mobile app, such as iVALT, linked to that number. The mobile app prompts the individual for biometric authentication, such as fingerprint or facial recognition. Upon successful verification, the user is granted permission to post the content, which is stamped with a verification mark to indicate authenticity. In the second method, if the digital content contains an embedded mobile number, the content management tool reads this number and sends a verification request to the corresponding mobile app. The mobile app then verifies the user's identity through biometric authentication and potentially other credentials. Once verified, the content is authorized for posting and stamped with a verification mark. This ensures that the shared content is both secure and traceable, as the system maintains a record of verified users who have posted it, thereby preventing unauthorized sharing and enhancing the credibility of the content on social media platforms.

The system further tracks the provenance of the digital content from its creation to the current state. This tracking provides a transparent history of the image's journey, ensuring that it has not been tampered with. Provenance details include the original creation date, modifications, and the identities of individuals who made changes, all of which are documented and stored securely.

By requiring user's to authenticate the digital content before posting on social media platform, the invention significantly reduces the risk of digital manipulation and fraud. This approach not only safeguards the integrity of content shared on social media but also enhances user confidence in the reliability and authenticity of the platform's digital ecosystem.

### BRIEF DESCRIPTION OF THE FIGURES

FIG. 1 is a flow chart illustrating the steps involved in validating and authenticating the images uploaded to social media platforms according to an embodiment of the present invention.

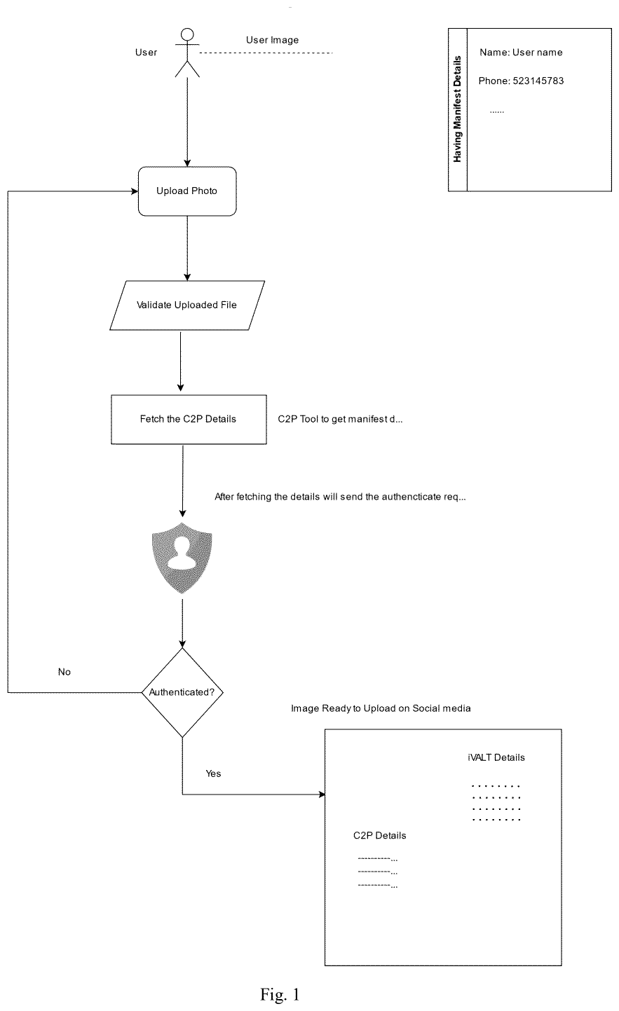

FIG. 2 is a flow chart illustrating the steps involved in accessing the digital content shared by a user on social media platform or any other app according to an exemplary embodiment of the present invention.

The foregoing and other features of the present invention will become apparent from the following description and appended claims, taken in conjunction with the accompanying drawings. Understanding that these drawings depict only several embodiments in accordance with the disclosure and are: therefore, not to be considered limiting of its scope, the disclosure will be described with additional specificity and detail through use of the accompanying drawings.

### DETAILED DESCRIPTION OF THE INVENTION

The present invention relates to a system and method to enhance the security, authenticity, and traceability of digital content such as images, videos, pdf, and word document by embedding user credentials within the digital content and biometric verification while uploading and accessing the digital content. The system integrates advanced technology, including the Coalition for Content Provenance and Authenticity (C2PA) standards and mobile app-based biometric authentication technology to tackle the challenges associated with verifying digital content and validating users identities.

The following detailed description refers to the accompanying drawings that show, by way of illustration, specific details, and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

However, these specific details are exemplary and should not be treated as the limitation to the scope of the invention. Throughout this specification the word “comprise” or variations such as “comprises or comprising”, will be understood to imply the inclusions of a stated element, integer or step, or group of elements, integers, or steps, but not the exclusions of any other element, integer or step or group of elements, integers, or steps. The present invention is designed to verify the authenticity of digital images, ensuring that only genuine and trustworthy images are shared on social media platforms.

The present invention is directed to a system and method for embedding user credentials into digital content, verifying access to digital content through a mobile-based authentication, and authenticating the digital content before they are uploaded to social media platform. The system preferably involves software that runs on at least one mobile device having at least one biometric sensor and at least one computing device that may be an interface device. The mobile device runs a mobile application and includes a display unit having a user interface. The system may further include software that runs on at least one server that communicates with the mobile device. The mobile device is in communication with the computing device or interface device. The server is in communication with the computing device or interface device and may be in communication with the mobile device.

According to another embodiment, the present invention discloses a system and method for embedding user credentials into digital content, verifying access to digital content through biometric authentication, and ensuring secure posting on social media platform. The system comprises a software application that resides on a user's device (e.g., a smart phone or any other electronic device) for embedding user's credentials associated with the content creator of digital content and verification of digital content, before they are uploaded to social media platform. The system allows content creators to embed their user credentials (e.g., name, phone number, email address, and time stamp) with Coalition for Content Provenance and Authenticity (C2PA) standards, thereby making the credentials tamper-evident and securely linked to the digital content. Additionally, the creator may include credentials of other individuals who may have authorized to access the digital content shared by the content creator on social media platform or any other application.

The user's device may include various electronic devices such as smartphones, tablets, and laptops capable of running the software application designed to verify and authenticate digital images before uploading them to social media platforms.

The software application further provides an intuitive and user-friendly interface for users to upload digital content for verification. Users can select digital content, initiate the upload process, and view the status of their digital content verification. The interface also allows users to manage their authentication settings and review embedded authenticity details.

The software application validates the uploaded digital content to ensure it meets the platform's technical requirements, such as file type, size, and resolution. This initial validation step checks for acceptable digital content formats (e.g., JPEG, PNG), appropriate file sizes, and sufficient resolution for social media standards.

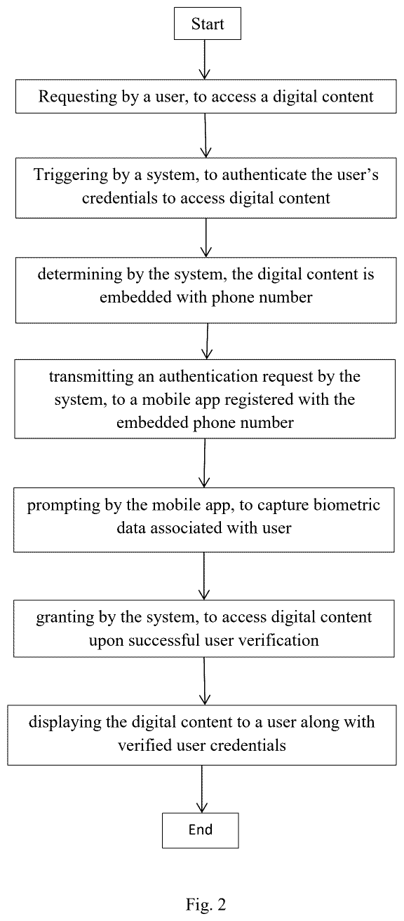

According to another aspect of the present invention, the system may provide access to digital content. The steps involved in accessing digital content are shown in FIG. 2. To access the digital content, a user may download the mobile application to the mobile device. A request is initiated by the user to access digital content on mobile application downloaded on the mobile device. The mobile application prompts the individuals to verify the credentials attempting to open the digital content. When an individual tries to access the secured digital content, the system initiates a thorough verification process to ensure that only authorized users can view the document. The application responsible for managing the content sends a verification request to a designated mobile app, such as iVALT, which is linked to the phone number embedded within the document. Upon receiving the request, the mobile app prompts the individual to undergo biometric authentication, such as fingerprint scanning or facial recognition. Depending on the specific security protocols in place, the app may also verify additional attributes of the individual, such as their geolocation or device ID. Once the individual successfully passes the biometric authentication, the system grants them access to the digital content. As a security measure, the content is displayed along with the credentials of the verified individual, providing transparency and accountability regarding who accessed the document. Furthermore, the content is stamped with a verification mark, indicating that the access attempt has been authenticated successfully.

According to another aspect of the present invention, the system allows user to securely post digital content on social media platform, ensuring that only verified users can share the content. This can be accomplished through two distinct methods. In the first method, if the individual's social media account is registered with a mobile number, the social media platform sends a verification request to a mobile app, such as iVALT, linked to that number. The mobile app prompts the individual for biometric authentication, such as fingerprint or facial recognition. Upon successful verification, the user is granted permission to post the content, which is stamped with a verification mark to indicate authenticity. In the second method, if the digital content contains an embedded mobile number, the content management tool reads this number and sends a verification request to the corresponding mobile app. The mobile app then verifies the user's identity through biometric authentication and potentially other credentials. Once verified, the content is authorized for posting and stamped with a verification mark. This ensures that the shared content is both secure and traceable, as the system maintains a record of verified users who have posted it, thereby preventing unauthorized sharing and enhancing the credibility of the content on social media platforms.

The system tracks the provenance of the digital content from its creation to the current state. This tracking provides a transparent history of the image's journey, ensuring that it has not been tampered with. Provenance details include the original creation date, modifications, and the identities of individuals who made changes, all of which are documented and stored securely.

The authentication server utilizes iVALT's dynamic variable-based authentication technology to verify the digital content. This technology involves variables that continuously change according to predefined rules, making the authentication process highly secure and resilient to tampering. Dynamic variables include factors like biometrics, location, and device-specific data that are used in real-time to authenticate the image.

The digital content is verified against a set of evolving criteria to ensure authenticity. This includes multiple factors of identity that are independently verified. The criteria may include biometric verification (e.g., facial recognition), device-specific data (e.g., IMEI number), and contextual information (e.g., geolocation).

Upon successful authentication, the system embeds the C2PA manifest details and iVALT authentication specifics into the digital content itself. This embedding provides a verifiable record of the image's authenticity and provenance. Embedded details include metadata such as creation timestamps, authorship, modification history, and the results of the dynamic authentication process.

The system prepares the authenticated digital content to upload on the social media platform. This includes ensuring that all necessary authenticity details are correctly embedded and the image meets the platform's requirements. The application packages the digital content with its embedded metadata and prepares it for upload to the user's social media account.

If the digital content fails authentication, the system promptly notifies the user, providing feedback on why the authentication failed and guiding them to re-upload the digital content. Notifications are clear and provide actionable steps for the user to correct any issues and attempt verification again.

The application assists users in repeating the upload and verification process. This iterative approach ensures that only authenticated and trustworthy images are shared. Guidance includes tips on improving image quality, ensuring correct metadata, and addressing any specific authentication failures.

The application allows users to set additional security parameters, such as geofences (specific geographic boundaries) and time windows for verification. These settings provide an extra layer of security by restricting verification to certain locations and times, reducing the risk of unauthorized access.

Users have control over their identity verification settings, supporting a decentralized approach to identity management. This includes the ability to manage which factors are used for verification and adjust settings to suit their security needs.

The system offers flexible APIs and SDKs for easy integration with existing social media platforms and identity management systems. These tools ensure quick and efficient deployment, allowing the system to be implemented without significant infrastructure changes.

The software application and authentication server are compatible with various devices and platforms, enabling broad adoption. Compatibility includes support for different operating systems (e.g., iOS, Android) and integration with popular social media platforms.

It should be understood that any of the computer operations described herein above may be implemented at least in part as computer-readable instructions stored on a computer-readable memory. It will of course be understood that the embodiments described herein are illustrative, and components may be arranged, substituted, combined, and designed in a wide variety of different configurations, all of which are contemplated and fall within the scope of this disclosure.

The foregoing description of illustrative embodiments has been presented for purpose of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

I/We claim:

1. A system for embedding and verifying user credentials in digital content, comprising:
a. a software application configured to run on a user device, the said user device having at least one biometric sensor;
b. an interface device for communication within the user device;
c. at least one server in communication with the user device and the interface device;
wherein the software application being configured to:
embed user credentials, including name, phone number, email, and timestamp, into the digital content with the Coalition for Content Provenance and Authenticity (C2PA) standards;
verify access to the digital content through biometric authentication using the mobile application; and
ensure secure posting of the digital content to social media platforms.

2. The system as claimed in claim 1, wherein the software application is further configured to allow the content creator to embed credentials of other authorized users who may access the digital content and store the digitally signed content on the user's device or a secure server.

3. The system as claimed in claim 1, wherein the software application provides an intuitive user interface for selecting digital content, initiating the upload process, and viewing the status of digital content verification.

4. The system as claimed in claim 1, wherein the software application validates the digital content for technical requirements such as file type, size, and resolution before uploading to social media platforms.

5. A method for embedding and verifying user credentials in digital content, comprising:
a. selecting digital content to be secured and authenticated;
b. embedding user credentials into the digital content using a software application according to C2PA standards;
c. storing the digitally signed content on a user device or a secure server;
d. sending a verification request to a mobile app linked to a phone number embedded within the document when access is attempted;
e. prompting the user to undergo biometric authentication through the mobile app;
f. granting access to the digital content upon successful biometric authentication;
g. displaying the content with the credentials of the verified user; and
h. stamping the content with a verification mark indicating successful authentication.

6. A method for securely posting digital content on social media platform, comprising:
a. receiving a verification request from a social media platform to a mobile app linked to the user's account;
b. prompting the user for biometric authentication through the mobile app;
c. granting permission to post the content upon successful verification; and
d. stamping the content with a verification mark indicating authenticity.

7. The method as claimed in claim 1, wherein if the digital content contains an embedded mobile number, the method further comprises:
a. sending a verification request to the corresponding mobile app using the embedded mobile number;
b. verifying the user's identity through biometric authentication and additional credentials; and
c. authorizing the content for posting upon successful verification.
